(19) United States
(12) Patent Application Publication
(10) Pub. No.: US 2004/0204045 A1
(43) Pub. Date: Oct. 14, 2004

(54) Wireless communication apparatus

(76) Inventors: Shih-Kuang Tsai, Shanghai (CN); Tai-Shui Ho, Shanghai (CN); Chin-Tung Chi, Shanghai (CN)

Correspondence Address: BIRCH STEWART KOLASCH & BIRCH, PO BOX 747, FALLS CHURCH, VA, 22040-0747, US

(21) Appl. No.: 10/145,725

(22) Filed: May 16, 2002

(51) Int. Cl. H04M 1/00

(52) U.S. Cl. 455/556.1; 455/550.1

(57) ABSTRACT

A wireless communication apparatus. The wireless communication apparatus comprises a main body having an antenna device, a memory device and a text editing device. The memory device stores versatile and plural text templates classified into plural categories. The text editing device selects the text templates according to the categories from the memory device to compose a phrase, wherein the phrase is outputted via the antenna device. The main body further comprises a loading device for loading the text templates. The main body further comprises a classifying device for classifying and conveying the text templates loaded by the loading device to the corresponding categories.

### BACKGROUND OF THE INVENTION

1. Field of the Invention

The present invention relates to a wireless communication apparatus, and in particular to a wireless communication apparatus providing the function of text transmission.

2. Description of the Related Art

Text transmission has become indispensable in current cellular phones or personal digital assistants (PDA). The text can be transmitted from a conventional electronic apparatus to a communication apparatus by operation of a wireless communication system.

In the conventional electronic apparatus, the steps of inputting characters are very complicated. For example, the characters are input via a standard CCITT keyboard. Usually, inputting a character requires pressing the keys three or four times while inputting a Chinese word requires pressing the keys seven or eight times. In order to solve the above problem, a predetermined text database is provided to let a user input and transmit the text quickly. The user can select and transmit a phrase from the predetermined text database. The common phrases include “I love you”, “see you later”, “please call back” and others.

However, the above text selection system has many drawbacks. For example, there is a limit to the number of phrases in any given database, so a user may not find a suitable phrase to transmit. Further, the text database cannot be expanded with new phrases. Additionally, the phrases are not classified, thus causing inconvenience for the user to select and transmit them.

### SUMMARY OF THE INVENTION

An object of the invention is to provide a wireless communication apparatus. The wireless communication apparatus comprises a main body having an antenna device, a memory device and a text editing device. The memory device stores versatile and plural text templates classified into plural categories. The text editing device selects the text templates according to the categories from the memory device to compose a phrase, wherein the phrase is outputted via the antenna device.

A detailed description will be given by the following embodiments with reference to the accompanying drawings.

### BRIEF DESCRIPTION OF THE DRAWINGS

The present invention can be more fully understood by reading the subsequent detailed description and examples with references made to the accompanying drawings, wherein:

FIG. 1 is a schematic view showing the structure of the wireless communication apparatus of the invention.

### DETAILED DESCRIPTION OF THE INVENTION

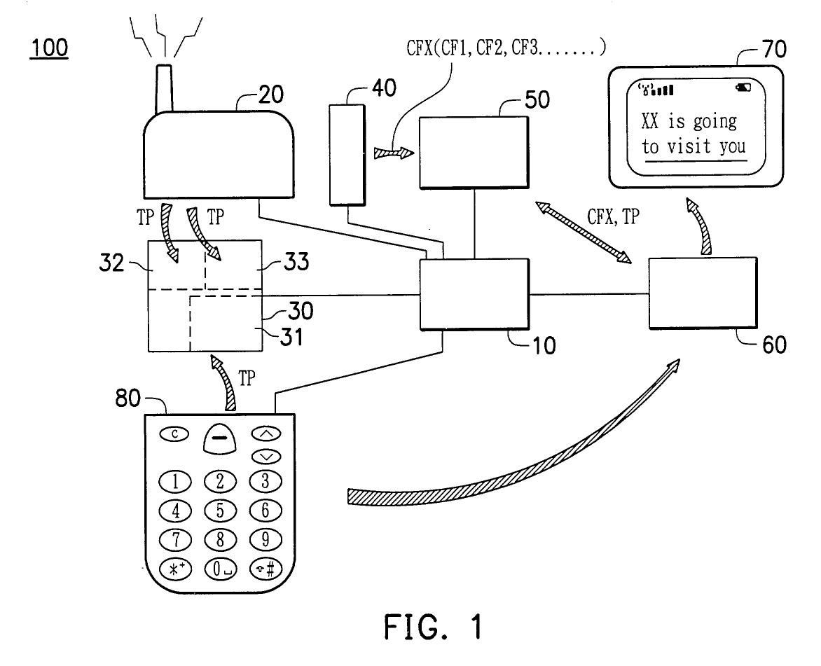

Referring to FIG. 1, the wireless communication apparatus of this embodiment is a cellular phone 100. The cellular phone 100 comprises a main body 10 having an antenna device 20, a loading device 30, a classifying device 40, a memory device 50, a text editing device 60, a display monitor 70 and a keyboard 80.

The loading device 30 loads various new text templates (TP) The classifying device 40 classifies the text templates loaded by the loading device 30 into plural categories CFX, such as CF1, CF2, CF3 and others. The memory device 50 stores the text templates of various categories CFX.

The text editing device 60 selects the text templates according to the categories CFX from the memory device 50 to compose a phrase. The phrase is outputted to another wireless communication apparatus such as a cellular phone via the antenna device 20.

The categories CFX of the text templates at least include “language”, “purpose” and “modifier” categories.

The “language” category may include “Chinese”, “English” and others.

The “purpose” category may include sub-categories “request”, “appreciation”, “apology”, and “common phrases”. The “request” sub-category further includes templates “please call back”, “please come back to company”, “please come back home as quickly as possible” and others. The “appreciation” sub-category further includes templates “thanks” and “appreciated”. The “apology” sub-category further includes templates “sorry” and others. The “common phrases” sub-category further includes “I am coming back tomorrow” and others.

The “modifier” category includes sub-categories “who”, “what”, “when”, “where” and others.

The “modifier” category may have added symbols such as “XX” to the text templates. For example, “invite you to have dinner” is displayed with “XX invite you to have dinner”. Thus, the user knows that it is possible to add additional words.

As to operation, for example, if the user plans to visit a friend in Hong Kong, he can transmit a phrase to notify his friend. First, the user can access the “language” category to select a language. Then, the user can select the “common phrases” of the “purpose” category to input “XX is going to visit you” via the display monitor 70 and the keyboard 80. And then, the user can access the “modifier” and select “who”. The user can input “I” to compose “I XX am going to visit you”. And then, the user can select “when” and input “on Saturday” to compose “I XX am going to visit you on Saturday”. The user can confirm the text to delete “XX”. Finally, the user can transmit the phrase “I am going to visit you on Saturday”.

As to text loading, the loading device 30 comprises a first receiving unit 31, a second receiving unit 32 and a third receiving unit 33.

The user can input personal text templates via the first receiving unit 31 and the keyboard 80.

The loading device 30 can receive the text templates from the network system via the antenna device 20, so that the user can renew and expand the text templates. For example, the user can download the text templates on an Internet web site via the WAP browser.

In addition, the user can transmit the personal text templates to another user (or another cellular phone) via the third receiving unit 33. The another user can receive and read the personal text templates via the receiving unit 33 and store the personal text templates in the memory device 50.

The wireless communication apparatus of this embodiment is a cellular phone 100, but the invention is not limited thereof. The wireless communication apparatus of this embodiment could also be a personal digital assistant (PDA). The user can quickly search the required text templates by accessing the various categories to compose a phrase. Additionally, the content of the text templates can be expanded. In the aspect of text transmission, the wireless communication apparatus of the invention is superior to the conventional wireless communication apparatus on both aspects of expanding capability and convenience.

While the invention has been described by way of example and in terms of the preferred embodiment, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A wireless communication apparatus, comprising:
A main body having an antenna device, a memory device and a text editing device, the memory device used to store versatile and plural text templates classified into plural categories, the text editing device used to select the text templates according to the categories from the memory device to compose a phrase, wherein the phrase is outputted via the antenna device.

2. The wireless communication apparatus as claimed in claim 1, wherein the main body further comprises a loading device for loading the text templates.

3. The wireless communication apparatus as claimed in claim 1, wherein the main body further comprises a classifying device for classifying and conveying the text templates loaded by the loading device to the corresponding categories.

4. The wireless communication apparatus as claimed in claim 1, wherein the main body further comprises a display monitor and a keyboard.

5. The wireless communication apparatus as claimed in claim 1, wherein the text editing device receives input from the keyboard and displays text content on the display monitor.

6. The wireless communication apparatus as claimed in claim 2, wherein the loading device further comprises:
a first receiving unit for loading the text templates via the keyboard;
a second receiving unit for receiving the text templates from a network system via the antenna device; and
a third receiving unit for receiving the text templates from another wireless communication apparatus via the antenna device.

7. The wireless communication apparatus as claimed in claim 6, wherein the network is the Internet.

8. The wireless communication apparatus as claimed in claim 1, wherein the categories include language, purpose and modifier.

9. The wireless communication apparatus as claimed in claim 8, wherein the purpose category further includes request, appreciation, apology and common phrases sub-categories.

10. The wireless communication apparatus as claimed in claim 8, wherein the modifier category further includes who, what, when and where sub-categories.

11. The wireless communication apparatus as claimed in claim 1, wherein the wireless communication apparatus is a cellular phone.

12. The wireless communication apparatus as claimed in claim 1, wherein the wireless communication apparatus is a personal digital assistant (PDA).
